(19) United States
(12) Patent Application Publication
(10) Pub. No.: US 2005/0262875 A1
(43) Pub. Date: Dec. 1, 2005

(54) Method of manufacturing glass tube and apparatus of manufacturing glass tube used therefor

(76) Inventors: Kohji Kusunoki, Kanagawa (JP); Shuichiro Kato, Kanagawa (JP); Yuichi Ohga, Kanagawa (JP)

Correspondence Address: MCDERMOTT WILL & EMERY LLP, 600 13TH STREET, N.W., WASHINGTON, DC, 20005-3096, US

(21) Appl. No.: 11/081,843

(22) Filed: Mar. 17, 2005

(30) Foreign Application Priority Data
Mar. 17, 2004 (JP) P. 2004-075783

(51) Int. Cl. C03B 23/04

(52) U.S. Cl. 65/105; 65/109; 65/283; 65/292; 65/166; 65/298; 65/160; 65/439

(57) ABSTRACT

In a method of manufacturing the glass tube of the invention, a glass tube having an inner diameter of a predetermined size is formed by forming a softened portion by heating a glass material and inserting an inner forming member to the softened portion. An outer diameter of the softened portion is formed into an outer diameter of a predetermined size by bringing an outer forming member movable in a direction orthogonal to a longitudinal direction axis of the glass material into contact with an outer circumference of the softened portion.

This application claims foreign priority based on Japanese patent application JP 2004-075783, filed on Mar. 17, 2005, the contents of which is incorporated herein by reference ins its entirety.

### BACKGROUND OF THE INVENTION

1. Field of the Invention

The present invention relates to a method of manufacturing a glass tube and an apparatus of manufacturing a glass tube used for the glass tube manufacturing method.

2. Description of the Related Art

A glass tube constituting a starting material of an optical fiber has to have a small noncircularity and a small eccentricity ratio, a uniform wall thickness, and excellent characteristics. In an optical fiber fabricated by a glass tube having a large noncircularity or a large uneven-thickness, a polarization mode dispersion (PMD) becomes a large value.

There have been proposed a method and an apparatus of manufacturing a glass tube having an inner diameter of a predetermined size by heating a glass material to form a softened portion and inserting a piercing member (inner forming member) having an inner diameter of a predetermined size into the softened portion of the glass material (refer to, for example, Japanese Patent Publication No. 2798465).

FIG. 8 shows a method and an apparatus of manufacturing the glass tube in a related-art. As shown in FIG. 8, a forming start end (right end in the drawing) of a silica glass rod 101 in a solid cylindrical shape constituting a starting material and a front end of a piercing member 105 provided to a front end (left end in the drawing) of a support rod 103 supported by cantilever supporting are butted to each other by aligning center axis lines thereof. Then, the piercing member 105 is gradually pressed into the silica glass rod 101 while heating to soften the silica glass rod 101 from a side of the forming start end by a heating mechanism (heater) 107 to thereby form the silica glass rod 101 into a silica glass tube having an inner diameter of a predetermined size.

In the case of the manufacturing apparatus shown in FIG. 8, the forming start end of the silica glass rod 101 is bonded with a dummy cylinder 109, and both sides of the silica glass rod 101 are supported by grasping a left end of the silica glass rod 101 and a right end of the dummy cylinder 109 respectively by chucks of feed tables, not illustrated.

The respective feed tables for supporting the silica glass rod 101 and the dummy cylinder 109 are movable along an axis of the silica glass rod 101. By moving the feed tables, the silica glass rod 101 is moved in an axial direction relative to the support rod 103 to realize to press the piercing member 105. Further, the respective feed tables include rotating drive mechanisms for rotating the grasped silica glass rod 101 around a center axis line thereof.

A base end (right end in the drawing) of the support rod 103 is supported in a cantilever state by being grasped by a chuck of a rod supporting base, not illustrated. Further, the rod supporting base includes a rotating drive mechanism for rotating the support rod 103 and is fixed to a base disposed therebelow, not illustrated.

The heating mechanism 107 is a heating furnace including a heating element (graphide) 112, and a coil 113 in a furnace member 111 surrounding an outer circumference of the silica glass rod 101.

The heating element 112 generates heat by conducting a predetermined alternating current to the coil 113 to heat the silica glass rod 101 up to a softening point (about 1600° C. or higher).

A die (outer forming member) 121 for forming an outer diameter of the silica glass rod 101 into a predetermined size by drawing is arranged at a position proximate to an outlet of the heating mechanism 107 through which a softened portion 101a of the silica glass rod 101 softened by heating by the heating element 112 passes.

As shown by FIG. 9, the die 121 is a hollow cylindrical member an inner diameter of which is finished to a predetermined size, and is fixedly supported by the heating element 112 or the furnace member 111 via a base member 123 tightly fitted to an outer periphery thereof.

The above-described apparatus of manufacturing the glass tube forms a silica glass tube having predetermined inner and outer diameters by pressing the silica glass rod 101 into the die 121 and pressing the piercing member 105 into the silica glass rod 101 by gradually moving the silica glass rod 101 to a side of the support rod 103 while rotating the silica glass rod 101 and the support rod 103 by pertinent rotational numbers in a state that the front end of the silica glass rod 101 is softened by heating.

It is indispensable to maintain a center axis of the die 121 and a center axis of the piercing member 105 on the same axis in order to manufacture a highly accurate glass tube without eccentricity ratio or uneven-thickness by using the above-mentioned method and the apparatus of manufacturing the glass tube.

Hence, aligning is carried by aligning the center axis of the piercing member 105 on the center axis of the die 121 before starting manufacture. However, even when the aligning is carried out carefully, in the above-described apparatus constitution, a small deviation is brought about in a diameter direction of the piercing member 105 in manufacturing by bending the support rod 103 supported in the cantilever state or uneven-thickness of the dummy cylinder 109. This deviation of the piercing member 105 constitutes a displacement relative to the center axis of the die 121 to produce eccentricity ratio or uneven-thickness of the formed glass tube.

Further, there is concern of destructing the piercing member 105 by subjecting a shear stress to the piercing member 105 by a deviation of the piercing member 105 in piercing.

Further, when a piercing load is varied by the deviation of the piercing member 105 in piercing, a piercing accuracy is deteriorated. Therefore, it is necessary to complicatedly control feeding operation and rotating operation of the silica glass rod 101 in accordance with the deviation of the piercing member 105 such that the piercing load is not varied.

### SUMMARY OF THE INVENTION

The invention provides a method of manufacturing a glass tube inexpensively capable of manufacturing a highly accurate glass tube without eccentricity ratio or uneven-thickness and an apparatus of manufacturing a glass tube used therefor by resolving the above-described problem.

To achieve this objective, the invention includes the following configuration.

A method of manufacturing a glass tube of the invention comprises:
heating a glass material to form a softened portion and pressing an inner forming member into the softened portion thereby forming the glass tube having an inner diameter of a predetermined size; and
bringing an outer forming member movable at least in a direction orthogonal to a longitudinal direction axis line of the glass material into contact with the softened portion thereby forming an outer diameter of the softened portion into a predetermined size.

Preferably, the manufacturing method is characterized in that the inner forming member centered to be concentric with a rotational axis of a cylinder in a cylindrical shape (which includes a hollow cylindrical shape and a solid cylindrical shape) bonded to a forming start end of the glass material is pressed into the softened portion.

Preferably, the manufacturing method is characterized in that the cylinder and the glass material are bonded and rotated in a state that a rotational number of the cylinder is different from a rotational number of the glass material.

Preferably, the manufacturing method is characterized in that the glass tube formed by the inner forming member and the outer forming member is forcibly cooled.

Further, an apparatus of manufacturing a glass tube of the invention comprises:
a heating mechanism for heating a glass material to form a softened portion;
an inner forming member pressed into the softened portion of the glass material; and
an outer forming member movable at least in a direction orthogonal to a longitudinal direction axis of the glass material and brought into contact with the softened portion of the glass material.

Preferably, the manufacturing apparatus is characterized in further comprising a support member for supporting the glass tube formed by the inner forming member and the outer forming member, a measuring member for measuring a deviation of the glass tube, and a support member adjusting mechanism for adjusting a supporting position of the support member to reduce a deviation based on a measured value of the measuring member.

As has been explained above, according to the invention, the outer forming member is movable at least in the direction orthogonal to the longitudinal axis of the glass material (including not only the orthogonal direction but also a skewed direction).

When the outer forming member is eccentric to a center axis of the inner forming member pressed into the softened portion of the glass material, the outer forming member is moved such that a force exerted to the outer forming member by the glass material becomes uniform in the direction orthogonal to the longitudinal axis direction of the glass material and the outer forming member is automatically centered relative to the inner forming member.

Therefore, centering operation of aligning the center axis of the outer forming member and the center axis of the inner forming member can simply be carried out before starting the manufacture and thus manufacturing operability can be promoted.

Further, since the outer forming member and the inner forming member can be maintained in a stable concentric state, \mathring{1} the formed glass tube can be prevented from bringing about eccentricity ratio or uneven-thickness and the highly accurate glass tube without eccentricity ratio or uneven-thickness can be manufactured, \mathring{2} an anticipated shear stress can be prevented from subjecting to the inner forming member, and the inner forming member can be prevented from being destructed, \mathring{3}variation in a piercing load caused by eccentricity ratio or uneven-thickness can be prevented and therefore, continuous piercing by a stable piercing load can be carried out and a control of feeding operation or rotating operation of the glass material is simplified.

### BRIEF DESCRIPTION OF THE DRAWINGS

FIG. 1 is a view of a total of an apparatus of manufacturing a glass tube for embodying a method of manufacturing a glass tube according to an embodiment of the invention.

FIG. 2 is a sectional view enlarging an essential portion of the apparatus of manufacturing the glass tube shown in FIG. 1.

FIG. 3 is a view taken along a section D-D of FIG. 2.

FIG. 4 is a view enlarging an essential portion showing an inner support member arranged in a cylinder.

FIG. 5 illustrates explanatory views for explaining operation in manufacturing a glass tube by an outer forming member and an inner forming member shown in FIG. 2, FIG. 5 (a) is an explanatory view of a step of bonding a cylinder to a glass material, FIG. 5 (b) is an explanatory view of a state of starting to draw a softened portion of the glass member to the outer forming member, and FIG. 5(c) is an explanatory view of a state of piercing the softened portion of the glass material drawn into the outer forming member by the inner forming member.

FIG. 6 is a cross-sectional view showing other example of the outer forming member used in the apparatus of manufacturing the glass according to the invention.

FIG. 7 illustrates cross-sectional views showing other examples of the outer forming member shown in FIG. 6.

FIG. 8 is a vertical sectional view of an essential portion of an apparatus of manufacturing a glass tube of a related art.

FIG. 9 is a sectional view taken along a section C-C of FIG. 8.

### DETAILED DESCRIPTION OF THE INVENTION

A detailed explanation will be given of preferable embodiments of a method of manufacturing a glass tube and an apparatus of manufacturing a glass tube used therefor according to the invention in reference to the drawings as follows.

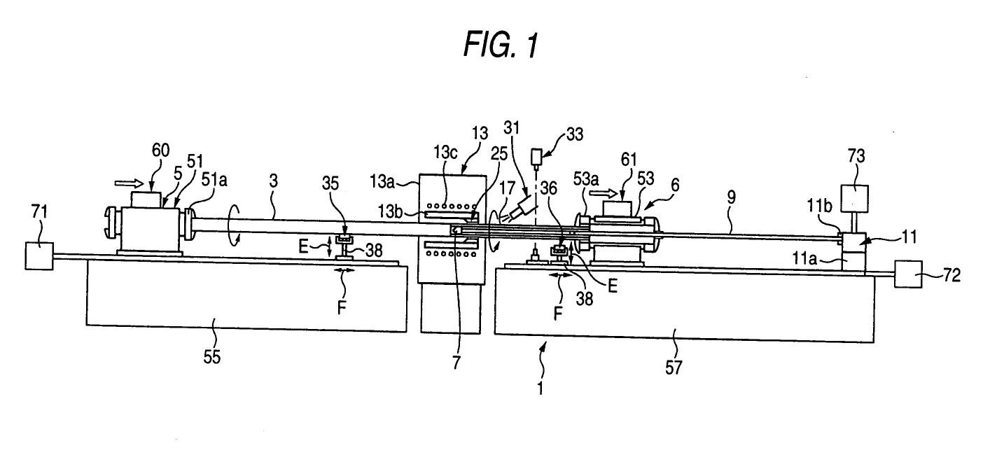

FIG. 1 through FIG. 3 show an apparatus of manufacturing a glass tube for embodying a method of manufacturing a glass tube according to an embodiment of the invention.

As shown by FIG. 1, an apparatus 1 of manufacturing a glass tube according to the embodiment comprises a glass supporting member 5, a cylinder supporting member 6, a support rod 9, a rod supporting member 11, a heating mechanism 13 and a moving member. The glass supporting member 5 supports a glass material 3 in a solid cylindrical shape constituting a starting material by horizontally directing a center axis (longitudinal direction axis) of the glass material. The cylinder supporting member 6 supports a cylinder 17 in a cylindrical shape (for example, a hollow cylindrical shape, or a solid cylindrical shape) bonded to a forming start end of the glass material 3 by horizontally directing a center axis of the cylinder 17. The support rod 9 includes an inner forming member 7 at a front end thereof. The rod supporting member 11 supports an end of the support rod 9 in the cantilever state such that a front end of the inner forming member 7 is opposed to the forming start end (right end in FIG. 1) of the glass material 3. The heating mechanism 13 heats the glass material 3 at a vicinity of a front end of the inner forming member 7 to form a softened portion of the glass material 3. The moving member moves the glass material 3 along a center axis line of the cylinder 17 relative thereto.

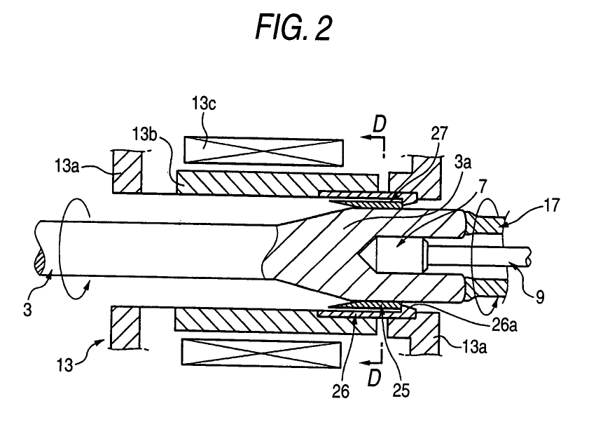

Further, as shown by FIG. 2, the glass material 3 is formed into a glass tube having an inner diameter of a predetermined size by heating a vicinity of the forming start end of the glass material 3 by the heating mechanism 13 to form a softened portion 3a and gradually pressing the inner forming member 7 into the softened portion 3a of the glass material 3.

The glass supporting member 5 is provided with a first feed mechanism 51 for grasping a base end (left end in FIG. 1) of the glass material 3 via a chuck 51a. The cylinder supporting member 6 is provided with a second feed mechanism 53 for grasping a base end (right end in FIG. 1) of the cylinder 17 via a chuck 53a.

Further, both sides of the glass material 3 bonded with the cylinder 17 at the forming start end are supported by the first and the second feed mechanisms 51, 53.

Further, the first and the second feed mechanisms 51, 53 are respectively arranged at bases 55, 57 movably along a center axis line of the cylinder 17 to constitute the moving member for moving the glass material 3 in an axial direction at a predetermined speed by drive forces from motors 71, 72.

Further, the chucks 51a, 53a of the first and the second feed mechanisms 51, 53 rotate the glass material 3 and the cylinder 17 respectively supported around the center axis lines thereof at predetermined rotational speeds by rotation driving members 60, 61.

The rod supporting member 11 grasps the base end of the support rod 9 by a chuck 11b provided to a stay 11a erected at the base 57. The support rod 9 grasped by the chuck 11b is rotated around a center axis thereof at a predetermined rotational speed by a rotation driving member 73. Further, the rod supporting member 11 is fixed to the base 57 different from the first and the second feed mechanisms 51, 53 explained above and is not moved in the axial direction of the support rod 9.

The heating mechanism 13 is a heating furnace including a heating element (for example, ceramics of zirconia or the like or graphide) 13b and a coil 13c in a furnace member 13a surrounding an outer circumference of the glass material 3. The heating mechanism, 13 heats the glass material 3 to a softening point (about 1600° C. or higher) by generating heat by the heating element 13b by conducting predetermined alternating current to the coil 13c.

As shown also by FIG. 2, an outer forming member 25 is provided to an inner side of the heating element 13b of the heating mechanism 13.

The outer forming member 25 according to the embodiment is a die substantially in a hollow cylindrical shape for forming an outer diameter of the softened portion 3a of the glass material 3 into an outer diameter of a predetermined size by bringing an inner peripheral face thereof into contact with the softened portion 3a of the glass material 3. Although as a material of the outer forming member 25, an oxide of Al₂O₃, ZrO₂ or the like or graphide is used, graphide is most preferable.

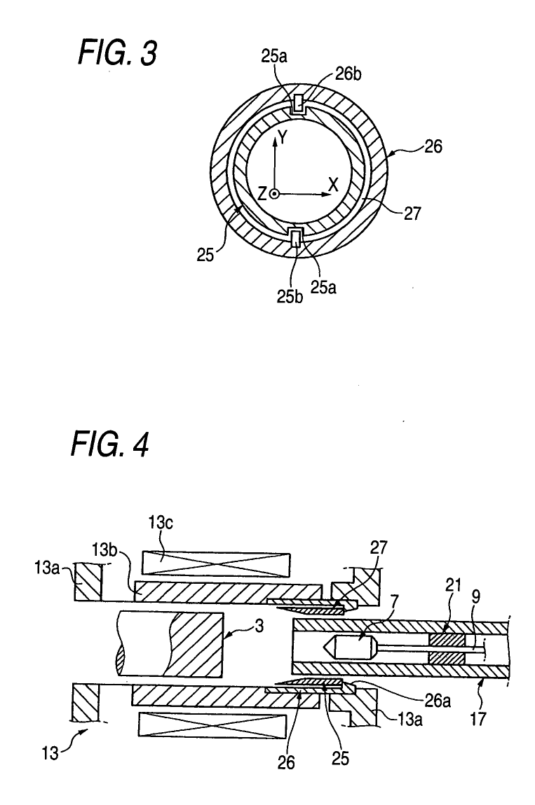

As shown by FIG. 2 and FIG. 3, the outer forming member 25 is coupled with an inner periphery of a base member 26 in a hollow cylindrical shape fixed to an inner periphery of the heating element 13b with play between the outer forming member 25 and the base member 26. Further, the base member 26 restricts the outer forming member 25 from moving in a drawing direction by locking an end portion of the outer forming member 25 by a locking portion 26a. In this embodiment, the locking portion 26a locks the end portion of the outer forming member 25, however, it is not limited to this structure so far as the base member 26 restricts the outer forming member 25. For example, the locking portion 26a may engage with the end portion of the outer forming member 25.

Further, the outer forming member 25 forms a gap 27 between the outer forming member 25 and an inner peripheral face of the base member 26 by constituting a movable state by being fitted to the base member 26 with play therebetween. The outer forming member 25 is held movably in a direction orthogonal to a longitudinal direction axis of the glass material 3 (X axis-Y axis directions of FIG. 3) by presence of the gap 27.

Further, in the case of the embodiment, as shown by FIG. 3, by engaging locking projections 25b, 26b projected from the inner peripheral face of the base member 26 with engaging grooves 25a, 25a formed at an outer peripheral face of the outer forming member 25 along an axis line thereof, the outer forming member 25 and the base member 26 are restricted from being rotated relative to each other.

Further, the apparatus 1 of manufacturing the glass tube according to the embodiment includes a cooling member 31, a deviation detecting sensor 33, support rollers 35, 36 as support members, and a support roller adjusting mechanism 38 as a support member adjusting mechanism. The cooling member 31 forcibly cools the glass tube immediately after having been formed in a predetermined shape by the inner forming member 7 and the outer forming member 25. The deviation detecting sensor 33 measures a deviation of the glass tube formed by the inner forming member 7 and the outer forming member 25. The support rollers support the glass material 3 and the glass tube after having been formed to reduce the deviation based on a measured value of the deviation detecting sensor 33. The support roller adjusting mechanism 38 adjusts supporting positions of the support rollers 35, 36.

The cooling member 31 blows cooling wind to, for example, the outer periphery of the glass tube formed in the predetermined shape by being heated to soften to forcibly cool to harden for preventing deformation of the glass tube. Further, by lowering a temperature to a surrounding of the glass tube, even a part other than a heat resistant part is made to be able to be used at the surrounding.

Further, in view of preventing a deformation, a length of the outer forming member 25 is prolonged to some degree such that the glass tube coming out from the outer forming member 25 is cooled to some degree. When the cooling member 31 is placed after the outer forming member, the length of the outer forming member 25 is set in consideration of the cooling effect.

The deviation detecting sensor 33 detects the deviation of the glass tube in no contact by monitoring a change in a region at which, for example, casting and receiving light is blocked by the glass tube.

The support roller adjusting mechanism 38 can adjust supporting positions of the support rollers 35, 36 respectively in a direction of the center axis line of the glass material 3 (arrow mark F direction) and a vertical direction orthogonal to the center axis line (arrow mark E direction).

Further, the feed mechanism 53 of the apparatus 1 of manufacturing the glass tube according to the embodiment can move the cylinder 17 so that the cylinder 17 be concentric with the center axis line of the inner forming member 7.

Before starting to process to form the glass tube, after adjusting the position such that the center axis line of the cylinder 17 coincides with the center axis line of the inner forming member 7, the cylinder 17 is bonded to the forming start end of the glass material 3.

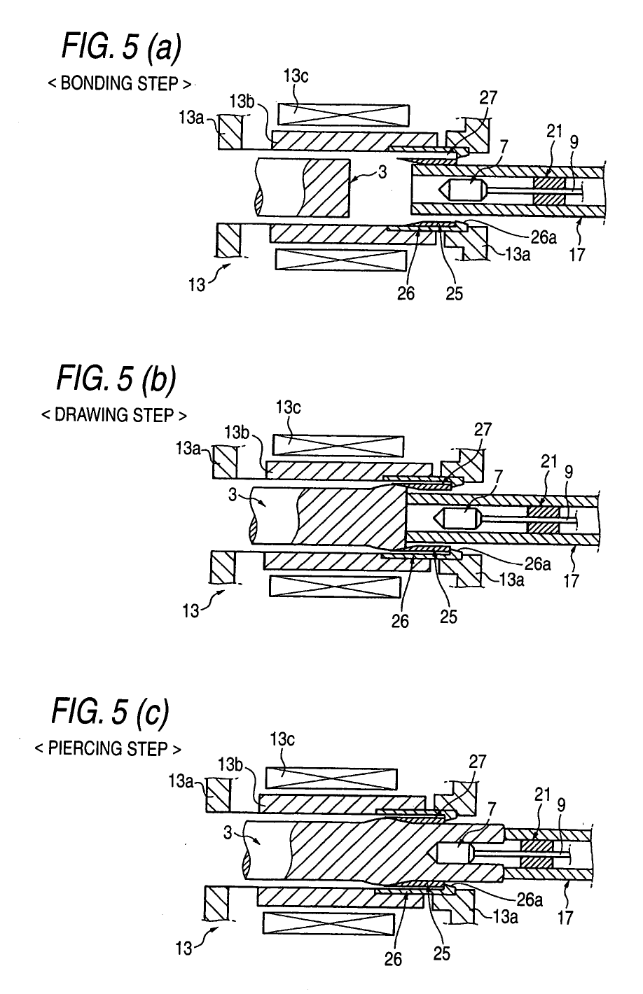

In the apparatus 1 of manufacturing the glass tube according to the embodiment, as shown by FIG. 5, a deviation stop piece 21 is fitted between the support rod 9 and the cylinder 17 to thereby restrain the deviation of the inner forming member 7 in forming.

Next, an explanation will be given of a method of manufacturing the glass tube having an inner diameter of a predetermined size from the glass material 3 by the apparatus 1 of manufacturing the glass tube, mentioned above.

First, as shown by FIG. 1, the base end of the glass material 3 as the starting material is fixed to the chuck 51a of the first feed mechanism 51. Further, the base end of the glass material 3 is previously integrated with a dummy member by a welding method or the like, and the dummy member is grasped by the chuck 51a.

Meanwhile, as shown by FIG. 4, the inner forming member 7 mounted to the front end of the support rod 9, which penetrates the deviation stop piece 21 and is supported by the rod supporting member by the cantilever supporting, is arranged in the cylinder 17 grasped by the second feed table 53.

Here, even when the cylinder 17 is rotated as it is, since the cylinder 17 is provided with the uneven-thickness, the inner forming member 7 is deviatedly rotated. Hence, the inner forming member 7 is restrained from being deviatedly rotated by adjusting the center axis line (rotational center axis) of the cylinder 17 by adjusting the chuck 53a grasping the cylinder 17 while rotating the cylinder 17 ad measuring the deviation of the inner forming member 7 (for example, equal to or smaller than 0.2 mm).

Further, as shown by FIG. 5 (a), the heating mechanism 13 is switched on while butting the forming start end of the glass material 3 and the front end of the cylinder 17 in a concentric state to rotate. That is, the heating element 13b is made to generate heat by generating induction power at the heating element 13b by conducting the coil 13c. Further, the portion of butting the glass material 3 and the cylinder 7 is heated up to the glass softening point (for example, 1600° C. or higher) to weld.

At this occasion, the outer forming member 25 is brought into a state of being seated on the base member 26 by dropping by an amount of the gap 27 shown in FIG. 3, or a state in which the inner peripheral face of the outer forming member 25 is brought into contact with the cylinder 17. Therefore, the center axis line of the inner forming member 7 a position of which have been adjusted and the center axis line of the outer forming member 25 are shifted from each other.

Next, a vicinity of the forming start end of the glass material 3 is heated to be softened to a drawable degree. Further, by moving the first and the second feed mechanisms 51, 53 in a right direction of FIG. 1 at a predetermined speed while rotating the glass material 3 and the cylinder 17 by a predetermined rotation by rotation drive means 73, 74 of the first and the second feed mechanisms 51, 53, as shown by FIG. 5 (b), the softened portion 3a of the glass material 3 is drawn into the outer forming member 25.

At this occasion, the glass material 3 starts to be pressed into the outer forming member 25 and the outer forming member 25 is brought into a state of being brought into contact with the softened portion 3a. Although the center axis line of the outer forming member 25 has been eccentric to the center axis line of the inner forming member 7, when brought into contact with the outer periphery of the glass material 3, the center axis line is pertinently moved in the direction orthogonal to the longitudinal direction axis of the glass material 3 such that a force exerted to the glass material by the inner peripheral face of the outer forming member 25 becomes uniform at respective points of the inner peripheral face. Further, the center axis line of the outer forming member 25 movable in the direction orthogonal to the longitudinal direction axis of the glass material 3 is aligned with the center axis line of the inner forming member 7.

Next, when the first and the second feed mechanisms 51, 53 are moved further in the right direction, as shown by FIG. 5(c), the inner forming member 7 is brought into contact with the center of the forming start end of the glass material 3 at its front end, and is pressed into the softened portion 3a which has been drawn into the outer forming member 25 to thereby pierce the glass material 3.

Further, the softened portion 3a inserted with the inner forming member 7 is widened to an outer side by being pressed by the inner forming member 7 to press the inner peripheral face of the outer forming member 25. As a result, the center axis line of the outer forming member 25 is automatically aligned with the inner forming ember 7 such that forces operated in the diameter direction of the softened portion 3a are balanced.

Piercing of the predetermined inner diameter is realized by piercing the softened portion 3a by the inner forming member 7, also the outer diameter is formed to the predetermined size by the outer forming member 25. Thus, the glass tube having the inner diameter and the outer diameter formed to the predetermined dimensions is formed.

The glass tube pierced by the inner forming member 7 is forcibly cooled by the cooling member 31 when the glass tube comes out from the outer forming member 25. The cooled glass tube becomes concentric with the cylinder 17 and rotated centering on the rotating shaft of the cylinder 17.

By applying a rotational difference between a rotational number of the glass material 3 pressed into the outer forming member 25 and a rotational number of the cylinder 17 drawn from the outer forming member 25, for example, by accelerating rotation of the cylinder 17 by 0.5 through 30 rpm, the softened portion 3a of the glass material 3 is started to rotate gradually as moving in the longitudinal axis direction and can coincide with the rotational axis of the cylinder 17 completely until being pressed into the outer forming member 25.

Further, the outer forming member 25, the softened portion 3a and the inner forming member 7 become concentric to balance forces thereof exerted to each other. The inner peripheral face of the outer forming member 25 is also brought into contact with the outer peripheral face of the glass tube cooled to harden. Therefore, thereafter, the center axis of the outer forming member 25 is not moved relative to the center axis of the inner forming member 7, and the outer diameter of the glass tube is not varied.

Therefore, the glass tube without uneven-thickness or a variation in the outer diameter can be manufactured by only centering the inner forming member 7 to be concentric with the rotational axis of the cylinder 17 in the cylindrical shape bonded to the forming start end of the glass material 3. In this way, the centering can simply be executed and the operability can be promoted.

Further, even when the inner forming member 7 is deviated in the diameter direction by bending of the support rod 9 or the uneven-thickness of the cylinder 17, the outer forming member 25 can be moved in the diameter direction by following the deviation of the inner forming member 7. Therefore, the deviation in the diameter direction of the inner forming member 7 does not constitute a displacement relative to the outer forming member 25 and the outer forming member 25 and the inner forming member 7 can be maintained in a stable concentric state. In this way, the eccentricity ratio or the uneven-thickness can be prevented from being brought about in the formed glass tube and continuous manufacturing of the highly accurate glass tube without the eccentricity ratio or the uneven-thickness is facilitated.

Further, an excessively large shear stress can be prevented from being subjected to the inner forming member 7 and the inner forming member 7 can be prevented from being destructed.

Further, also the variation in the piercing load can be prevented and therefore, continuous piercing by the stable piercing load can be carried out and a control of feeding operation or rotating operation or the like of the glass material 3 is simplified.

Further, in piercing, the deviation of the glass tube is measured by the deviation detecting sensor 33 and positions of the support rollers 35, 36 are adjusted based on a measured value thereof such that the deviation of the glass tube is reduced.

According to the embodiment, the outer forming member 25 is not fixed to the heating mechanism 13 and therefore, the formed glass tube is supported by the chuck of the feed mechanism 53 in the cantilever state. When the optical perform becomes large-sized, there is a possibility of operating an excessively large bending movement to the cylinder 17 chucked thereby.

Hence, the glass tube is supported at an optimum height while restraining the deviation of the glass tube by adjusting the positions of the support rollers 35, 36 as described above.

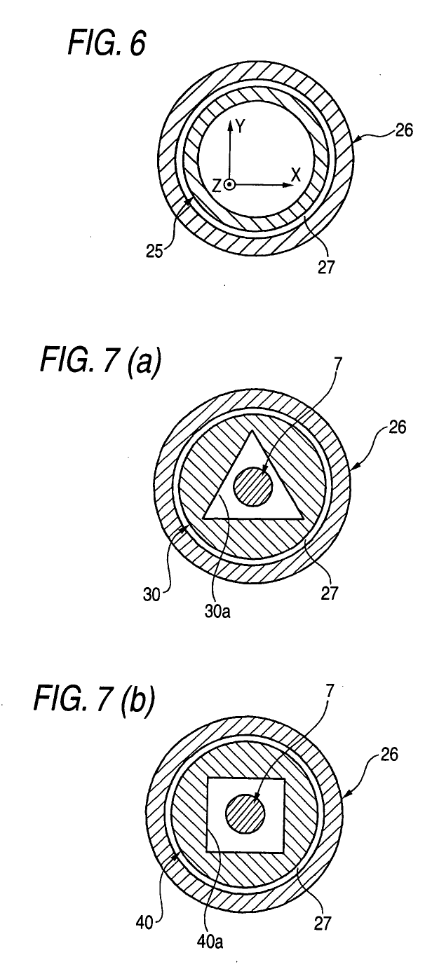

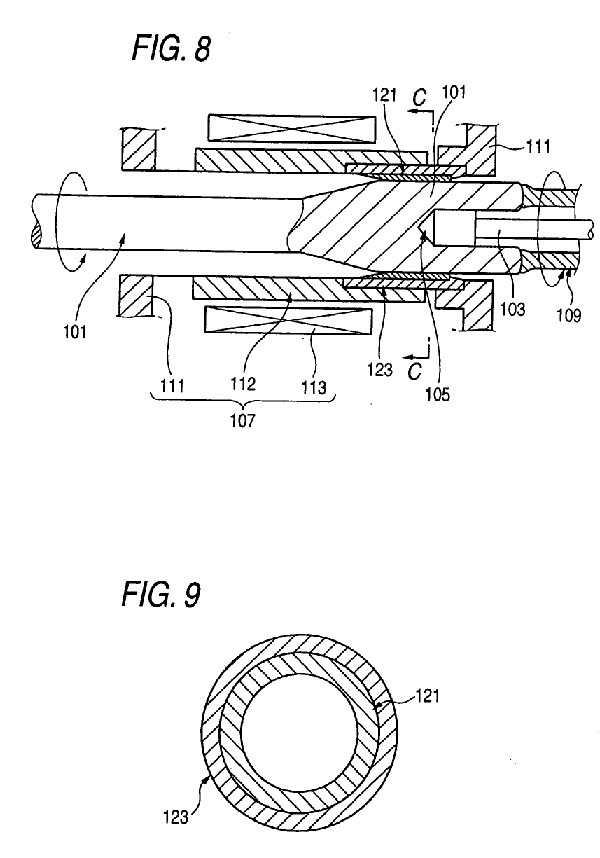

Further, although according to the above-described embodiment, there is constituted a structure of restricting rotation of the outer forming member 25 and the base member 26 relative to each other by engaging the locking projection 26b and the engaging groove 25a, it is also conceivable to constitute a structure of not restricting rotation relative to each other without providing the locking projection and the engaging groove as in a section shown by FIG. 6.

Further, a specific structure of the outer forming member according to the invention is not limited to the die substantially in the hollow cylindrical shape having the hole of the section in the circular shape as shown by the above-described embodiment.

For example, there can be constituted an outer forming member by a forming member rotated relative to the outer peripheral face of the softened portion and having a pair of forming faces arranged at a predetermined interval by interposing a rotating axis thereof.

Further, an outer forming member can also be constituted by a ring-like member rotated relative to the outer peripheral face of the softened portion and having at least three forming faces (a section of which constitutes a polygonal shape) arranged at equal distances and brought into contact with the softened portion.

For example, an outer forming member 30 shown in FIG. 7 (a) is a die having a hole 30a of a section in a triangular shape and is constituted by a ring-like member having three forming faces. Further, an outer forming member 40 shown in FIG. 7 (b) is a die having a hole 40a of a section in a quadrangular shape and is constituted by a ring-like member having four forming faces.

Further, the glass material according to the invention may be a solid bar manufactured by a method of a VAD method or the like or may be a hollow bar manufactured by an OVD method or the like. Further, the glass material may be pure silica glass or a glass material added with chlorine or fluorine.

Further, although according to the above-described embodiment, there is shown an example of manufacturing the glass tube from the solid glass material, the invention also includes a method of manufacturing a glass tube by pressing an inner forming member into a hollow hole of a hollow glass material and enlarging or contracting the hollow hole to the predetermined diameter.

Further, although according to the above-described embodiment, there is shown the apparatus of manufacturing the glass tube of a horizontal type for piercing the glass material horizontally, the invention also includes an apparatus of manufacturing a glass tube of a vertical type for manufacturing a glass tube having a predetermined inner diameter by vertically hanging a glass material and pressing an inner forming member into a softened portion of the glass material from a lower end side thereof. In this case, there is not a concern of hanging the softened portion in a diameter direction and therefore, it is not necessarily needed to rotate the glass material and a forming start end of the glass material is grasped.

### Example

Various data are measured and compared in the case of manufacturing the glass tube by the above-described apparatus 1 of manufacturing the glass tube and the case of manufacturing the silica glass tube from the silica glass rod by the apparatus of manufacturing the glass tube of the related art in which the outer forming member is fixed to the heating member.

The outer forming member 25 is constituted by the base member 26 having the inner diameter of 195 mm and a movable die having an outer diameter of 191 mm.

Further, before starting to manufacture the glass tube respectively by the manufacturing apparatus 1 of the embodiment or the manufacturing apparatus of the related art, positions of the center axis of the cylinder 17 and the center axis of the inner forming member 7 are adjusted to coincide with each other and the cylinder 17 is bonded to the forming start end of the glass material 3. Further, the deviation stop piece 21 in the circular ring shape is fitted between the support rod 9 and the cylinder 17 to restrain the deviation of the inner forming member 7 in forming (refer to FIG. 5).

When the glass tube is manufactured by the manufacturing apparatus 1 of the embodiment, by using the movable die, the hole which has been pierced skewedly (a deviation of 1 mm by piercing 1000 mm) in the related art is pierced straightly and therefore, also the eccentricity ratio is converged within 0.5%.

Further, when the glass tube is manufactured by the manufacturing apparatus 1 of the embodiment, an initial piercing load (piercing load at initial stage of starting to pierce) which has been equal to or larger than an average of 100 kgf by the fixed die (manufacturing apparatus of related art) is reduced to 5 kgf by using the movable die.

Further, it has been found that when the glass tube is manufactured by the manufacturing apparatus 1 of the embodiment, the piercing load is stably low from an initial stage of starting to pierce until finishing to pierce.

Further, a width of a deviation in a center value of the piercing load under a plurality of manufacturing conditions which differ by the outer diameter of the inner forming member 7, the inner diameter of the outer forming member 25 and a forming speed is considerably improved to be about 3 kgf when the movable die of the invention is used from an average of 30 kgf by the fixed die of the related art.

Further, when the glass tube is manufactured by the apparatus 1 of manufacturing the glass tube according to the invention, it can be confirmed that sliding sound at high frequency can be prevented from being emitted in piercing, which is effective also for low noise formation in manufacturing the glass tube.

Further, it can be confirmed that lateral sway of the support rod 9 can be reduced, which is effective also for long service life formation of the support rod 9.

It will be apparent to those skilled in the art that various modifications and variations can be made to the described preferred embodiments of the present invention without departing from the spirit or scope of the invention. Thus, it is intended that the present invention cover all modifications and variations of this invention consistent with the scope of the appended claims and their equivalents.

1. A method of manufacturing a glass tube comprising:
heating a glass material to form a softened portion and pressing an inner forming member into the softened portion thereby forming the glass tube having an inner diameter of a predetermined size; and
bringing an outer forming member movable at least in a direction orthogonal to a longitudinal direction axis line of the glass material into contact with the softened portion thereby forming an outer diameter of the softened portion into a predetermined size.

2. The method of manufacturing a glass tube according to claim 1, wherein the inner forming member centered to be concentric with a rotational axes of a cylinder in a cylindrical shape bonded to a forming start end of the glass material is pressed into the softened portion.

3. The method of manufacturing a glass tube according to claim 2, wherein the cylinder and the glass material are bonded and rotated in a state that a rotational number of the cylinder is different from a rotational number of the glass material.

4. The method manufacturing a glass tube according to claim 1, wherein the glass tube formed by the inner forming member and the outer forming member is forcibly cooled.

5. The method manufacturing a glass tube according to claim 2, wherein said cylindrical shape of cylinder is a hollow cylindrical shape.

6. An apparatus of manufacturing a glass tube comprising:
a heating mechanism for heating a glass material to form a softened portion;
an inner forming member pressed into the softened portion of the glass material; and
an outer forming member movable at least in a direction orthogonal to a longitudinal direction axis of the glass material and brought into contact with the softened portion of the glass material.

7. The apparatus of manufacturing a glass tube according to claim 6, further comprising:
a support member for supporting the glass tube formed by the inner forming member and the outer forming member;
a measuring member for measuring a deviation of the glass tube; and
a support member adjusting mechanism for adjusting a supporting position of the support member to reduce a deviation based on a measured value of the measuring member.
